(19) United States
(12) Patent Application Publication
(10) Pub. No.: US 2026/0051800 A1
(43) Pub. Date: Feb. 19, 2026

(54) MAGNETIC INDUCTION YAW MOTOR BASED ON HALL EFFECT

(71) Applicant: Shenzhen Ou Yi Zhi Zao Ke Ji Co.,Ltd., Shenzhen (CN)

(72) Inventors: Chao Li, Shenzhen (CN); Haoze Wu, Shenzhen (CN)

(21) Appl. No.: 18/922,482

(22) Filed: Oct. 22, 2024

(30) Foreign Application Priority Data
Aug. 19, 2024 (CN) 2024220048943

(51) Int. Cl. H02K 33/00; H02K 11/215

(52) U.S. Cl. CPC H02K 33/00; H02K 11/215

(57) ABSTRACT

A magnetic induction yaw motor based on Hall effect comprises a fixing frame, a stator assembly, a rotor assembly, a detection unit and a control unit electrically connected to the detection unit; the rotor assembly comprises a mounting base, a motor shaft and a rotor body; the Hall sensor real-time detects the position of the rotor body and transmits the position information to the control unit; the control unit processes the data detected by the detection unit and controls the current input to the stator coil; the position of the rotor body is real-time detected by using Hall sensors, thereby obtaining the position information of the cutter head of the hair cutter device; the control unit controls the current input to the stator coil for accurately controlling the subsequent actions of the rotor body, so that the closed-loop motor control based on the feedback on the blade position is realized.

### TECHNICAL FIELD

This invention generally relates to the technical field of motors, and more particularly, to a magnetic induction yaw motor based on Hall effect.

### BACKGROUND

Presently, when using a hair cutter, a movable blade moves back and forth at a high frequency, and this process is completed by means of a motor and a transmission structure. Conventional transmission structures normally adopt a motor to propel an eccentric wheel to rotate at a high speed, and the eccentric wheel is connected to an end portion of a cutter holder, thereby propelling the blade to reciprocate at a high frequency. The aforesaid structure has following shortcomings: 1. to realize the transmission, the eccentric wheel and the blade holder are rotationally connected, and there is friction between the eccentric wheel and the blade holder during rotation; the high-frequency rotation results in accelerated wear of points where the eccentric wheel and the blade holder are connected, so that frequent replacement and high cost become inevitable; due to the aforesaid transmission structure, a larger accommodating cavity is required inside the housing of the hair cutter, making one end of the hair cutter adjacent to the cutter head cumbersome such that and the size of the hair cutter is increased.

To solve the aforesaid problems, magnetic induction yaw motors have appeared on the market. By means of applying the magnetic induction principle and changing the design of the rotor and stator body, two swing members are directly propelled to reciprocate in a staggered manner. In addition, while the swing members reciprocate, an elastic member and a limiting member also swing along with the swing members, thereby improving the stability of the staggered reciprocating. For example, Chinese patent CN114123702A discloses a brushless electromagnetic suspension vibration motor, which effectively solves the technical problem caused by using an eccentric wheel structure during the transmission of the cutter head.

However, the aforesaid yaw motor cannot sense the position of the movable blade relative to the fixed blade, and therefore, it is impossible to regulate and control the precise position when the blade moves, resulting in problems such as dead cutter head, increased friction and aged mechanical components. Under such circumstances, the cutting effect of the hair cutter cannot be guaranteed.

### SUMMARY

The purpose of the present invention is to provide a magnetic induction yaw motor based on Hall effect. By means of Hall sensors, the position of the rotor body is detected in real time, thereby obtaining the position information of the cutter head (the movable blade) of the hair cutter device. Meanwhile, the control unit is used to control the current input to the stator coil for accurately controlling the subsequent actions of the rotor body, so that the closed-loop motor control based on the feedback on the blade position is realized.

To achieve the above purpose, the present invention adopts the following technical solution: a magnetic induction yaw motor based on Hall effect comprises a fixing frame, a stator assembly fixedly arranged at a lower end of the fixing frame, a rotor assembly transversely swingably arranged in the fixing frame, a detection unit, and a control unit electrically connected to the detection unit; the stator assembly comprises a stator body and a stator coil wound around the periphery of the stator body; the rotor assembly comprises a mounting base, a motor shaft fixedly mounted at an upper end of the mounting base, and a rotor body fixedly mounted at a lower end of the mounting base; elastic members are connected between two sides of the rotor assembly and the fixing frame, and a reset elastic force is provided by the elastic member when the rotor assembly swings transversely in a reciprocating manner; the detection unit comprises at least one Hall sensor, and the Hall sensor is fixedly installed on the fixing frame or the stator body; the Hall sensor detects the position information of the rotor body in real time and transmits the position information to the control unit; the control unit processes the data detected by the detection unit and controls the current input to the stator coil.

In another embodiment of the present invention, there are two groups of Hall sensors, and two Hall sensors are symmetrically arranged on two sides of the fixing frame or the stator body for detecting the position of the rotor body in real time.

In another embodiment of the present invention, the lower portion of the motor shaft is provided with a base portion. There are two groups of elastic members that are symmetrically arranged on two sides of the base portion, and the other side of the elastic member relative to the base portion is connected to the fixing frame.

In another embodiment of the present invention, a track strip for supporting and guiding the rotor assembly is arranged in the fixing frame, and the track strip is transversely arranged. The mounting base or the motor shaft is provided with a guide groove for interacting with the track strip.

In another embodiment of the present invention, the lower end of the mounting base is provided with at least one rotor body, the rotor body is transversely suspended at the upper end of the stator body, and the rotor body is capable of swinging in a reciprocating manner under the action of the stator assembly.

In another embodiment of the present invention, the rotor body is a permanent magnet.

Compared with the prior art, the present invention has the following advantages: the position of the rotor body is detected in real time by means of the Hall sensor, thereby obtaining the position information of the cutter head (the movable blade) of the hair cutter device, and the control unit is used to control the current (intensity, magnitude, and flow direction, etc.,) input to the stator coil for accurately controlling the subsequent actions of the rotor body; namely, the closed-loop motor control based on the feedback on the blade position is realized.

### BRIEF DESCRIPTION OF THE DRAWINGS

FIG. 1 is a schematic diagram illustrating an exemplary overall structure of the present invention;

FIG. 2 is a schematic diagram illustrating a front view of the present invention;

FIG. 3 is a schematic diagram illustrating the detection of a single detection unit of the present invention;

FIG. 4 is a schematic diagram illustrating the detection of two detection units of the present invention;

In Figures: 10-Fixing Frame, 20-Stator Assembly, 21-Stator Body, 22-Stator Coil, 30-Rotor Assembly, 31-Mounting Base, 32-Motor Shaft, 321-Base Portion, 33-Rotor Body, 34-Elastic Member, 35-Track Strip, 40-Detection Unit.

### DETAILED DESCRIPTION

Drawings are combined hereinafter to further elaborate the technical solution of the present invention.

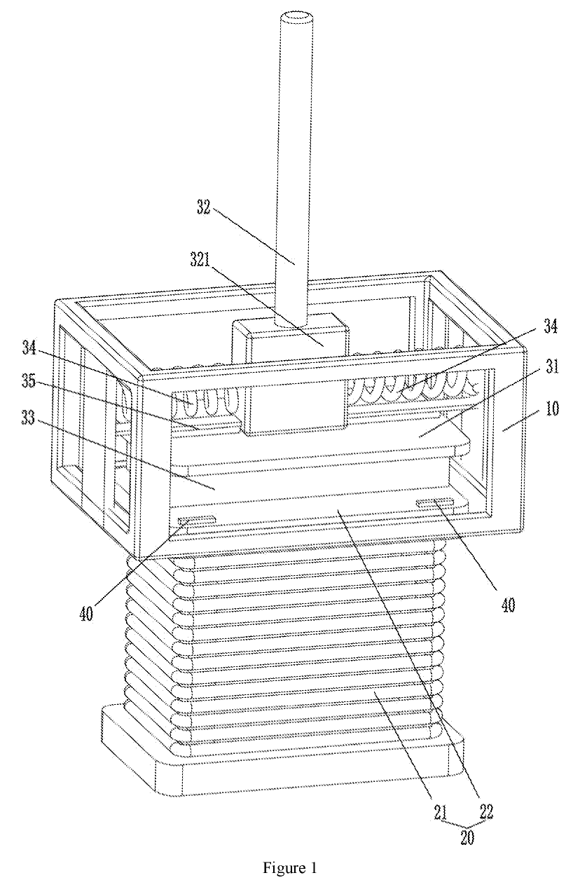

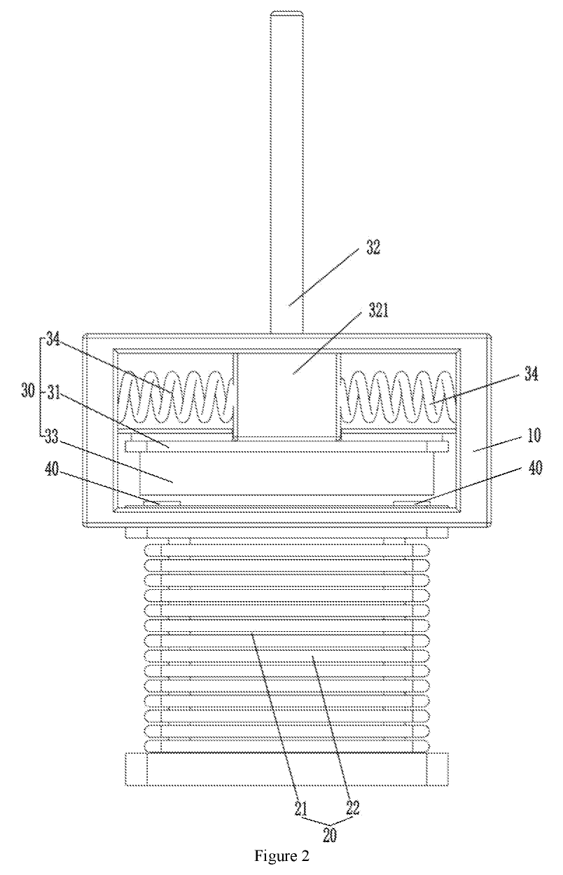

Referring to FIGS. 1-4, the magnetic induction yaw motor based on Hall effect of the present invention comprises a fixing frame 10, a stator assembly 20 fixedly arranged at a lower end of the fixing frame 10, and a rotor assembly 30 transversely swingably arranged in the fixing frame 10. The aforesaid forms the main structure of the present invention.

The stator assembly 20 comprises a stator body 21 and a stator coil 22 wound around the periphery of the stator body 21. The rotor assembly 30 comprises a mounting base 31, a motor shaft 32 fixedly mounted at an upper end of the mounting base 31, and a rotor body 33 fixedly mounted at a lower end of the mounting base 31. Specifically, the rotor body 33 is a permanent magnet, and the motor shaft 32 is configured to connect a cutter head. The motion information such as displacement and rotation of the cutter head is consistent with the motion information of the permanent magnet. Therefore, obtaining the position variation information of the rotor body 33 means obtaining the position information of the cutter head (the movable blade) of a hair cutter device. Namely, a closed-loop motor control based on the feedback on the blade position is achieved. Elastic members 34 are connected between two sides of the rotor assembly 30 and the fixing frame 10, and a reset elastic force is provided by the elastic member 34 when the rotor assembly 30 swings transversely in a reciprocating manner. The magnetic induction yaw motor of the present invention further comprises a detection unit 40 and a control unit electrically connected to the detection unit 40.

The detection unit 40 comprises at least one Hall sensor, and the Hall sensor is fixedly installed on the fixing frame 10 or the stator body 21. Preferably, the Hall sensor is fixedly installed on the stator body 21, and the Hall sensor detects the position information of the rotor body 33 in real time and transmits the position information to the control unit. The control unit processes the data detected by the detection unit 40 and controls the current input to the stator coil 22. In the present invention, the control unit controls parameters such as the intensity, magnitude and flow direction of the current input to the stator coil 22, thereby accurately controlling subsequent actions of the rotor body 33.

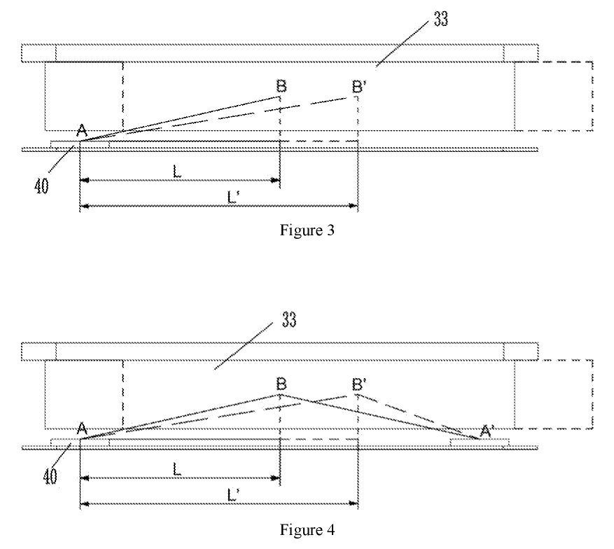

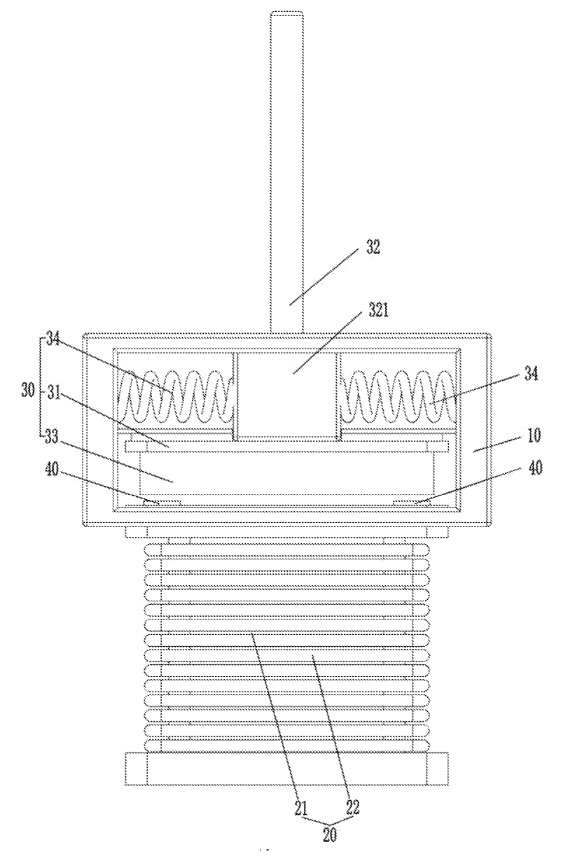

Referring to FIGS. 3 and 4, when the Hall sensor operates, the intensity of the magnetic field around the Hall sensor is measured. Theoretically, the magnetic field data measured by the Hall sensor is the magnetic field intensity in the three-dimensional environment, and if the measurement result is visualized through an isosurface, a sphere may be used to represent the equal magnetic field intensity measured by the corresponding Hall sensor. Because the motion path of the rotor of the yaw motor is merely a transverse movement, the magnetic field intensity remains unchanged in a space where the rotor body 33 itself is the coordinate system, and the magnetic field intensity in the longitudinal direction and the vertical direction is unchanged, thereby allowing the operating condition to be simplified into a two-dimensional problem. The principle of using Hall sensors measuring the intensity of the surrounding magnetic field by means of voltage variations of semiconductor chips is briefly described herein. For example, under normal conditions of a hair cutter device, each time the cutter head swings transversely, the cutter head should move to the left position before moving transversely to the right or to the right position before moving transversely to the left. However, when the hair is thick, due to the high friction, the yaw motor may move in the opposite direction before reaching the set left or right position, resulting in poor use effect. Compared with the prior art, the yaw motor of the present invention adjusts the current intensity of the stator coil 22 through the control unit, thereby enabling the cutter head to continue to move to the set position.

In the present invention, the position of the rotor body 33 is detected in real time by means of the Hall sensor, thereby obtaining the position information of the cutter head (the movable blade) of the hair cutter device, and the control unit is used to control the current (intensity, magnitude, and flow direction, etc.,) input to the stator coil 22 for accurately controlling the subsequent actions of the rotor body 33. Namely, the closed-loop motor control based on the feedback on the blade position is realized.

Referring to FIG. 3, when there is only one Hall sensor, after the magnetic induction yaw motor is assembled, a fixed position A of the Hall sensor is determined, and in the initial state, the vertical distance between the fixed position A of the Hall sensor and the initial position B of the rotor body 33 in the height direction and the horizontal distance in the horizontal direction are known. Because the Hall sensor performs mapping calibration on the magnetic field intensity and the relative position angle relationship before operation, after the magnetic field intensity is measured, the relative relationship may also be expressed by using an included angle formed between the fixed position and the center of the rotor body 33. Namely, when the rotor body 33 swings transversely, the Hall sensor may real-time detect the included angle X formed between a horizontal line and a straight line formed by the fixed position A of the Hall sensor and a real-time position B’ of the rotor body 33. Meanwhile, the Hall sensor calculates a distance between the real-time position B’ of the rotor body 33 and the initial position B through real-time processing of the control unit.

The distance between the real-time position B’ of the rotor body 33 and the initial position B may be calculated and obtained in various ways. As an example, the horizontal transverse distance L between the fixed position A and the initial position B is known. The distance L’ between the fixed position A and the real-time position B’ may be obtained by means of arccosX and the vertical distance from the real-time position B’ to the fixed position A, and the distance between B and B’ is the distance between L’ and L.

Referring to FIG. 4, in some embodiments, there are two groups of Hall sensors, and two Hall sensors are symmetrically arranged on two sides of the fixing frame 10 or the stator body 21 for detecting the position of the rotor body 33 in real time. After the magnetic induction yaw motor is assembled, the fixed positions A and A’ of the two Hall sensors are determined. In this embodiment, the real-time detection of the Hall sensor on the left side is taken as an example. In the initial state, the vertical distance between the fixed position A of the left Hall sensor and the initial position B of the rotor body 33 in the height direction as well as the horizontal distance in the horizontal direction are known. Because the Hall sensor performs mapping calibration on the magnetic field intensity and the relative position angle relationship before operation, after the magnetic field intensity is measured, the relative relationship may also be expressed by using an included angle formed between the fixed position and the center of the rotor body 33. Namely, when the rotor body 33 swings transversely, the left Hall sensor real-time detects the included angle X between the horizontal line and the straight line formed by the fixed position A of the left Hall sensor and the real-time position B’ of the rotor body 33, and meanwhile, the left Hall sensor calculates the distance between the real-time position B’ of the rotor body 33 and the initial position B through real-time processing of the control unit. In this embodiment, the position of the rotor body 33 is detected in real time through the two Hall sensors, so that the rotor body 33 possesses a corrected function and the detection precision is significantly enhanced. Specifically, after the rotor body 33 moves, the relative position between the rotor body 33 and the stator body 21 varies. Namely, the Hall sensor on one side measures the decrease of the magnetic field intensity, and the Hall sensor on the other side measures the increase of the magnetic field intensity. As shown in FIG. 4, the rotor body 33 moves to the right side, the measured value of the left Hall sensor is decreased, and the measured value of the sensor on the right side is increased. The Hall sensor close to the rotor body 33 is higher in detection precision relative to the Hall sensor away from the rotor body 33. Therefore, by correcting the detection data, the detection precision of the two Hall sensors are greatly improved.

In some embodiments, the lower portion of the motor shaft 32 is provided with a base portion 321. There are two groups of elastic members 34 that are symmetrically arranged on two sides of the base portion 321, and the other side of the elastic member 34 relative to the base portion 321 is connected to the fixing frame 10. A track strip 35 for supporting and guiding the rotor assembly 30 is arranged in the fixing frame 10, and the track strip 35 is transversely arranged. The mounting base 31 or the motor shaft 32 is provided with a guide groove for interacting with the track strip 35, and the rotor assembly 30 is supported and guided through the track strip 35, so that the rotor assembly 30 only reciprocates transversely.

The lower end of the mounting base 31 is provided with at least one rotor body 33, the rotor body 33 is transversely suspended at the upper end of the stator body 21, and the rotor body 33 is capable of swinging in a reciprocating manner under the action of the stator assembly.

The above are merely preferred embodiments of the present invention, and therefore, equivalent changes or modifications made according to the structure, feature and principle described in the present invention shall fall into the scope defined by the claims of the present invention.

What is claimed is:

1. A magnetic induction yaw motor based on Hall effect, comprising:
a fixing frame (10),
a stator assembly (20) fixedly arranged at a lower end of the fixing frame (10),
a rotor assembly (30) transversely swingably arranged in the fixing frame (10),
a detection unit (40), and
a control unit electrically connected to the detection unit (40), wherein the stator assembly (20) comprises:
a stator body (21) and a stator coil (22) wound around the periphery of the stator body (21), wherein the rotor assembly (30) comprises:
a mounting base (31), a motor shaft (32) fixedly mounted at an upper end of the mounting base (31), and a rotor body (33) fixedly mounted at a lower end of the mounting base (31), wherein elastic members (34) are connected between two sides of the rotor assembly (30) and the fixing frame (10), and a reset elastic force is provided by the elastic member (34) when the rotor assembly (30) swings transversely in a reciprocating manner, wherein the detection unit (40) comprises:
at least one Hall sensor, and the Hall sensor is fixedly installed on the fixing frame (10) or the stator body (21), wherein the Hall sensor detects the position information of the rotor body (33) in real time and transmits the position information to the control unit, and wherein the control unit processes the data detected by the detection unit (40) and controls the current input to the stator coil (22).

2. The magnetic induction yaw motor based on Hall effect of claim 1, wherein there are two groups of Hall sensors, and wherein two Hall sensors are symmetrically arranged on two sides of the fixing frame (10) or the stator body (21) for detecting the position of the rotor body (33) in real time.

3. The magnetic induction yaw motor based on Hall effect of claim 1, wherein the lower portion of the motor shaft (32) is provided with a base portion (321), wherein there are two groups of elastic members (34) that are symmetrically arranged on two sides of the base portion (321), and wherein the other side of the elastic member (34) relative to the base portion (321) is connected to the fixing frame (10).

4. The magnetic induction yaw motor based on Hall effect of claim 1, wherein a track strip (35) for supporting and guiding the rotor assembly (30) is arranged in the fixing frame (10), wherein the track strip (35) is transversely arranged, and wherein the mounting base (31) or the motor shaft (32) is provided with a guide groove for interacting with the track strip (35).

5. The magnetic induction yaw motor based on Hall effect of claim 2, wherein a track strip (35) for supporting and guiding the rotor assembly (30) is arranged in the fixing frame (10), wherein the track strip (35) is transversely arranged, and wherein the mounting base (31) or the motor shaft (32) is provided with a guide groove for interacting with the track strip (35).

6. The magnetic induction yaw motor based on Hall effect of claim 3, wherein a track strip (35) for supporting and guiding the rotor assembly (30) is arranged in the fixing frame (10), wherein the track strip (35) is transversely arranged, and wherein the mounting base (31) or the motor shaft (32) is provided with a guide groove for interacting with the track strip (35).

7. The magnetic induction yaw motor based on Hall effect of claim 4, wherein the lower end of the mounting base (31) is provided with at least one rotor body (33), the rotor body (33) is transversely suspended at the upper end of the stator body (21), and the rotor body (33) is capable of swinging in a reciprocating manner under the action of the stator assembly.

8. The magnetic induction yaw motor based on Hall effect of claim 5, wherein the rotor body (33) is a permanent magnet.
